(19) United States
(12) Patent Application Publication
(10) Pub. No.: US 2026/0090517 A1
(43) Pub. Date: Apr. 2, 2026

(54) PET DRINKING DEVICE

(71) Applicant: DO-IT INNOVATIONS TECHNOLOGY CO.,LTD., ZHUHAI (CN)

(72) Inventors: JIACHENG HUANG, ZHUHAI (CN); SHAOCHUN TIAN, ZHUHAI (CN)

(21) Appl. No.: 18/918,779

(22) Filed: Oct. 17, 2024

(30) Foreign Application Priority Data
Sep. 30, 2024 (CN) 202422407479.2

(51) Int. Cl. A01K 7/02

(52) U.S. Cl. CPC A01K 7/02

(57) ABSTRACT

A pet drinking device includes a water tank including a water storage chamber for storing water and a drinking water trough for pets to drink water; a circuit board arranged on the water tank; a water pumping mechanism electrically connected to the circuit board, the water pumping mechanism arranged in the water storage chamber and configured to circulate water in the water storage chamber and the drinking water trough when the circuit board is driven; and a filter element assembly. The filter element assembly includes a softened water quality filter element for softening water quality, a heavy metal filter element for filtering heavy metals and an antibacterial and deodorizing filter element for removing peculiar smell, the softened water quality filter element, the heavy metal filter element and the antibacterial and deodorizing filter element are arranged on the water tank for filtering water during water circulation.

### CROSS-REFERENCE TO RELATED APPLICATIONS

The application claims priority of Chinese patent application CN2024224074792, filed on 2024-09-30, which is incorporated herein by reference in its entireties.

### TECHNICAL FIELD

The present invention relates to the technical field of pet products, in particular to a pet drinking device.

### BACKGROUND

With the elevation of people's living standards, more and more families keep pets. In order to make pets drink more water, water dispensers with a water-flowing function have emerged in the market. For the health of pet drinking water, existing pet water dispensers generally filter the water before discharge. However, existing pet water dispensers generally adopt filter cotton to filter the water, and this filtering mode cannot effectively remove the peculiar smell and bacteria in the water. As a result, the water quality becomes increasingly dirty with the increase of use time, resulting in more and more bacteria and viruses in the water body, which brings health risks to pets. Moreover, the water flow sound of the existing water dispenser is loud, which increases the environmental noise and affects the user experience.

### SUMMARY

The main purpose of the present disclosure is to provide a pet drinking device, which addresses the issues that the existing pet water dispensers are incapable of effectively eliminating peculiar smells and performing sterilization.

A pet drinking device includes: a water tank including a water storage chamber for storing water and a drinking water trough for pets to drink water; a circuit board arranged on the water tank; a water pumping mechanism electrically connected to the circuit board, the water pumping mechanism arranged in the water storage chamber and configured to circulate water in the water storage chamber and the drinking water trough when the circuit board is driven; and a filter element assembly, wherein the filter element assembly includes a softened water quality filter element for softening water quality, a heavy metal filter element for filtering heavy metals and an antibacterial and deodorizing filter element for removing peculiar smell, the softened water quality filter element, the heavy metal filter element and the antibacterial and deodorizing filter element are arranged on the water tank for filtering water during water circulation.

Further, a material of the antibacterial and deodorizing filter element includes nano mineral crystal elements.

Further, the water tank is provided with a filter element housing, a drinking water outlet and a backwater channel, the filter element housing is arranged on the backwater channel, and the drinking water outlet is connected to the water pumping mechanism and the drinking water trough; the backwater channel includes a water return port arranged on the water tank and positioned on a sidewall of the drinking water trough, at least three accommodating chambers communicating each other and arranged along the circulating water direction in the filter element housing, and a filter element water inlet and a filter element water outlet arranged on the filter element housing; the water return port is connected to the filter element water inlet, each of two sides of the filter element water inlet is respectively connected to the accommodating chamber and the backwater channel positioned on one side, and each of two sides of the filter element water outlet is respectively connected to the accommodating chamber and the water storage chamber positioned on the other side; the antibacterial and deodorizing filter element, the softened water quality filter element, and the heavy metal filter element are respectively installed in one accommodating chamber.

Further, the antibacterial and deodorizing filter element, the softened water quality filter element, and the heavy metal filter element are arranged in sequence in the direction adjacent to the filter element water outlet.

Further, a height of a bottom surface of the accommodating chamber on one side adjacent to the filter element water inlet is higher than a height of the bottom surface of the accommodating chamber on one side adjacent to the filter element water outlet.

Further, the backwater channel further includes a buffer channel arranged on a top of the filter element housing, each of two sides of the buffer channel is respectively connected to the water return port and the filter element water inlet, and the buffer channel is obliquely arranged downwards along the direction adjacent to the filter element water inlet.

Further, a partition plate is arranged between each two adjacent accommodating chambers of the at least three accommodating chambers, the backwater channel further includes a first water passage arranged on the filter element housing, a first water passage opening arranged on a top of the partition plate close to one side of the filter element water inlet, and a second water passage opening arranged on a bottom of the partition plate close to one side the filter element water outlet; the buffer channel is connected to the filter element water inlet through the first water passage, the filter element water inlet is arranged close to a bottom of the accommodating chamber, the first water passage opening is connected to the filter element water inlet through the accommodating chamber, and the second water passage opening is connected to the filter element water outlet through the accommodating chamber.

Further, the backwater channel further includes a second water passage arranged on the water tank, the second water passage is positioned on the filter element housing, and each of two sides of the second water passage is respectively connected to the buffer channel and the water return port.

Further, the filter element housing includes a filter element surface housing and a filter element bottom housing, the filter element surface housing is connected to the filter element bottom housing form the accommodating chamber, the first water passage and the filter element water inlet, the buffer channel is arranged on a top portion of the filter element surface housing, the partition plate is arranged on the filter element surface housing, and the filter element water outlet is arranged on the filter element bottom housing.

Further, a water flow trough is further arranged on a top portion of the water tank, the water flow trough is connected to the drinking water trough, a height of one end of the water flow trough connected to the drinking water trough is lower than a height of one end of the water flow trough far away from the drinking water trough, and the drinking water outlet is arranged on a bottom surface of the water flow trough and is positioned at the end of the water flow trough far away from the drinking water trough.

Further, the water tank includes a main body bottom housing and an upper main body detachably connected to the main body bottom housing, the water storage chamber is formed by connecting the upper main body and the main body bottom housing, the drinking water outlet, the water return port, the water pumping mechanism and the circuit board are arranged on the upper main body.

Further, he filter element housing is detachably arranged on the upper main body.

Further, a storage groove for accommodating the filter element housing is provided at a bottom of the upper main body, a supporting block protrudes from a side wall of the upper main body corresponding to the storage groove, a butting block configured in cooperation with the supporting block is provided on the filter element housing, and the butting block is positioned above the supporting block when the filter element housing is placed in the storage groove.

Further, the upper main body is provided with a battery electrically connected to the circuit board.

Further, the battery is a rechargeable battery, the upper main body is provided with a charging interface for external connection of a power supply, and the charging interface is electrically connected to the circuit board.

Further, the upper main body includes a middle housing and a main body surface housing connected to the middle housing to form a mounting chamber, the circuit board and the battery are arranged in the mounting chamber, the water storage chamber is formed by surrounding the middle housing and the main body bottom housing, the drinking water outlet and the water return port are arranged on the main body surface housing, the water pumping mechanism 3 is connected to the drinking water outlet through a tube, and the tube passes through the middle housing.

Further, the main body surface housing is provided with a functional operating part electrically connected to the circuit board, and the circuit board is configured to control working of the water pumping mechanism or adjust driving pow of the electrolysis module when a user operates the functional operating part.

Further, a wireless module configured to communicate with an external equipment is arranged in the mounting chamber, and the wireless module is electrically connected to the circuit board.

Further, a UV lamp connected to the circuit board is arranged on a bottom of the middle housing.

Further, a metal water basin is arranged on the main body surface housing, the metal water basin is fixed with the main body surface housing during injection molding of the main body surface housing, and a bottom surface and a side wall of the metal water basin are respectively a bottom surface and at least part of side wall of the drinking water trough.

Beneficial effects of the present invention are as follows. The pet drinking device in this embodiment, the softened water quality filter element, the antibacterial and deodorizing filter element and the heavy metal filter element are arranged on a water circulation path. Moreover, the softened water quality filter element is configured for softening water quality, the antibacterial and deodorizing filter element is configured for removing the peculiar smell in the circulating water, and the heavy metal filter element is configured for removing the heavy metals in the circulating water. This arrangement effectively removes impurities, odors, heavy metals in the circulating water and inhibits the growth of bacteria, effectively purifies the water quality, ensures the hygiene and safety of pet drinking water, and improves the drinking water quality for pets, which is conducive to the growth, development and health of pets.

### BRIEF DESCRIPTION OF THE DRAWINGS

FIG. 1 is a 3D schematic diagram of a pet drinking device of the present invention;

FIG. 2 is a 3D schematic diagram of the pet drinking device from another view of the present invention;

FIG. 3 is a disassembly diagram of an upper main body and a main body bottom housing of the pet drinking device of the present invention;

FIG. 4 is a sectional diagram cut along a center line of the filter element assembly of the pet drinking device of the present invention;

FIG. 5 is a schematic diagram after removing the main body bottom housing of the pet drinking device of the present invention;

FIG. 6 is a disassembly diagram of the upper main body and a filter element housing of the pet drinking device of the present invention;

FIG. 7 is a 3D schematic diagram of the filter element housing of the pet drinking device of the present invention;

FIG. 8 is an exploded diagram of the filter element housing of the pet drinking device of the present invention;

FIG. 9 is a disassembly diagram after removing the main body bottom housing and a water pumping mechanism of the pet drinking device of the present invention;

FIG. 10 is a 3D schematic diagram of an electrolysis module of the pet drinking device of the present invention;

FIG. 11 is an exploded diagram of the electrolysis module of the pet drinking device of the present invention; and

FIG. 12 is an exploded diagram of the electrolysis module from another view of the pet drinking device of the present invention.

### DETAILED DESCRIPTION OF THE EMBODIMENTS

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein may be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts may be exaggerated to better illustrate details and features of the present disclosure.

The term “comprising” when utilized, means “including, but not necessarily limited to”; it specifically indicates open-ended inclusion or membership in the so-described combination, group, series, and the like. The disclosure is illustrated by way of example and not by way of limitation in the figures of the accompanying drawings in which like references indicate similar elements. It should be noted that references to “an” or “one” embodiment in this disclosure are not necessarily to the same embodiment, and such references can mean “at least one”. In addition, the terms “first” and “second” are used for descriptive purposes only and cannot be understood as indicating or implying relative importance or implying the number of indicated technical features. Thus, the features defined as “first” and “second” may explicitly or implicitly include one or more of the features. In the description of embodiments of the application, “a plurality of” means two or more, unless otherwise specifically defined.

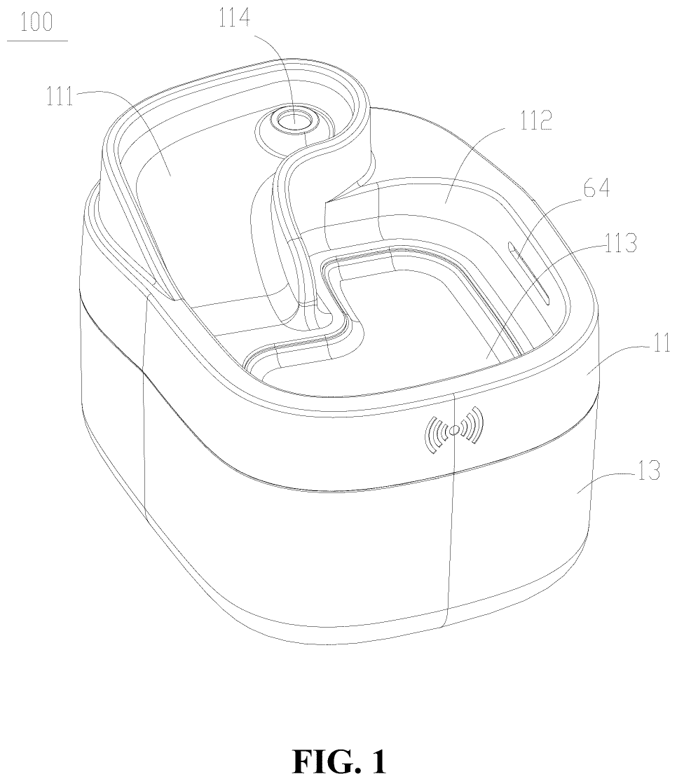

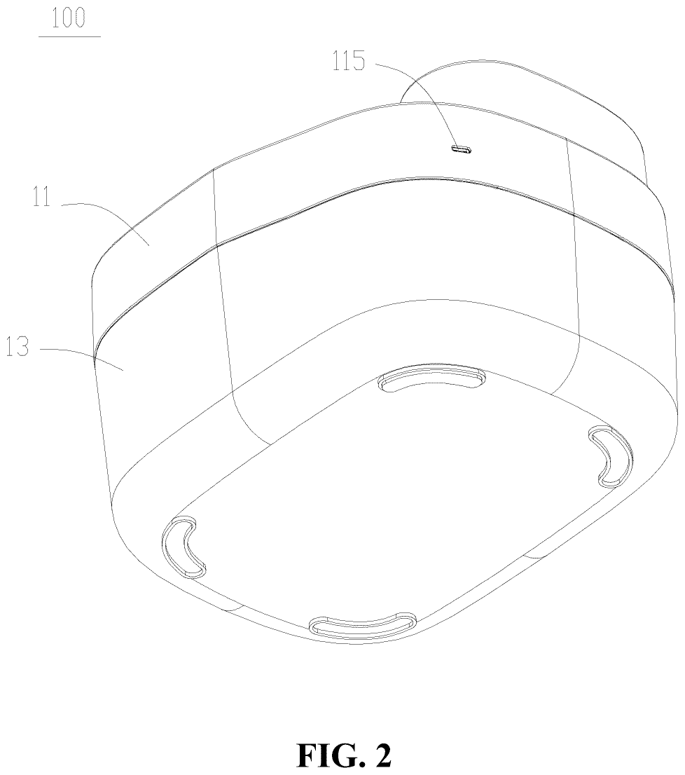

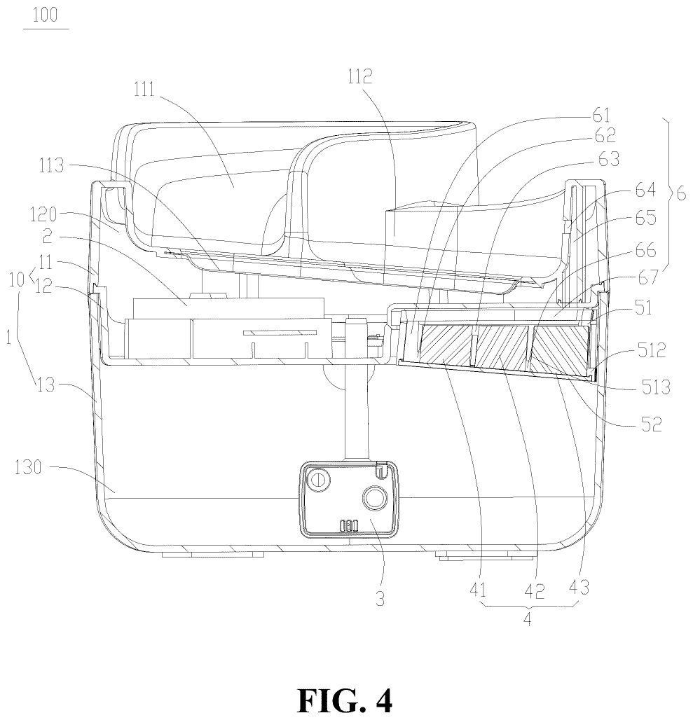

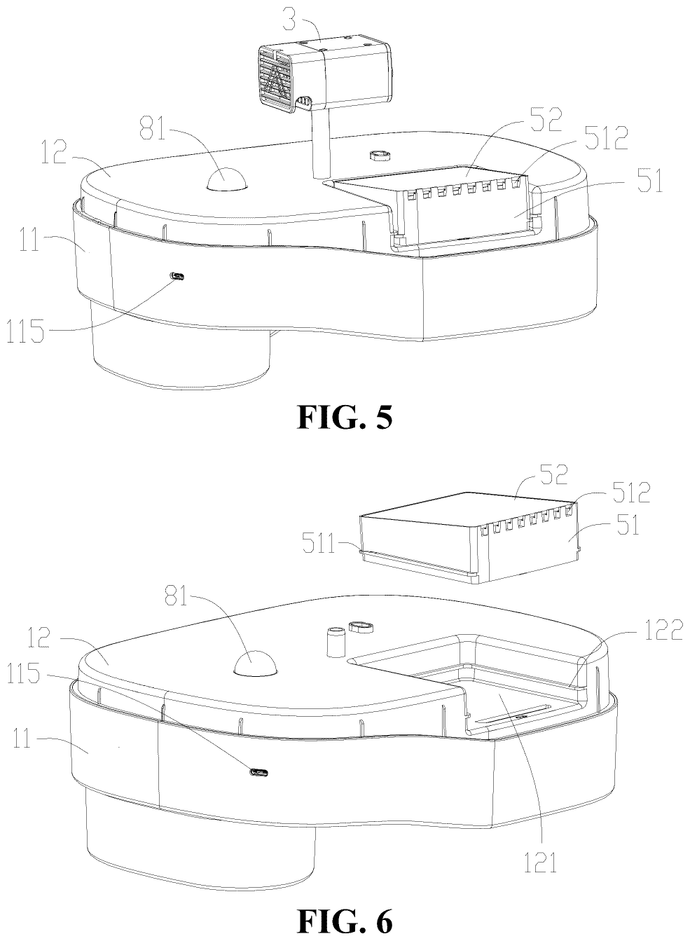

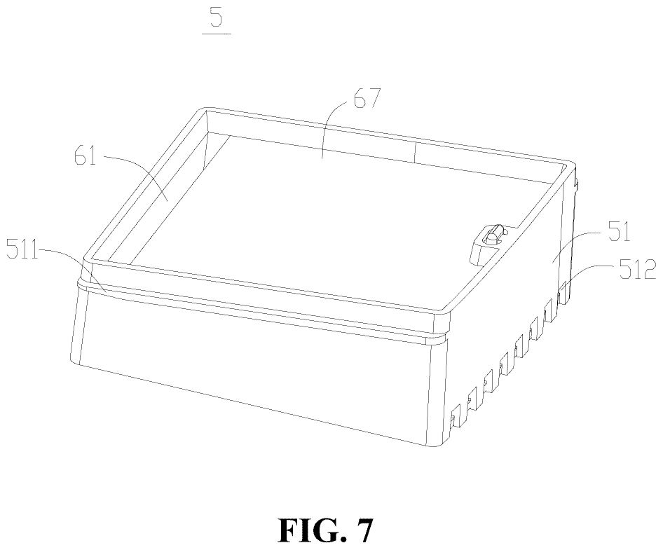

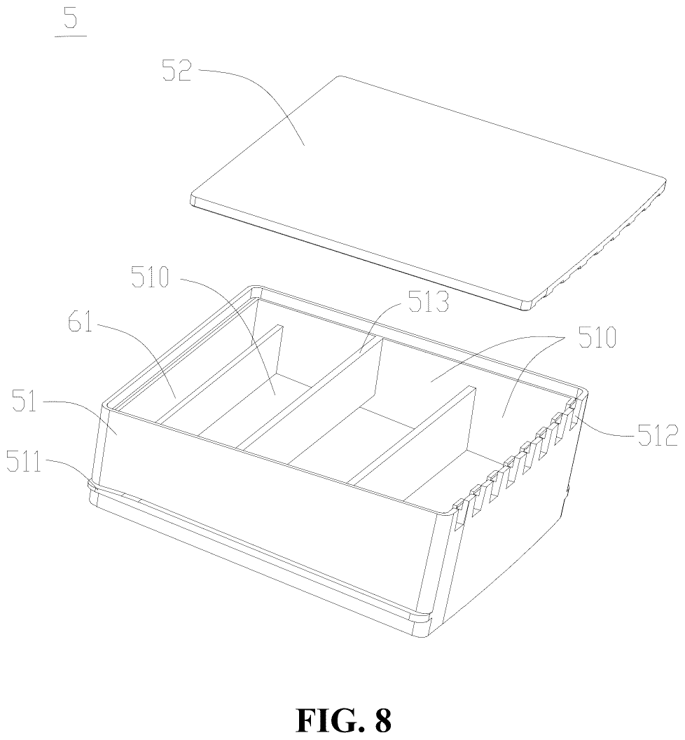

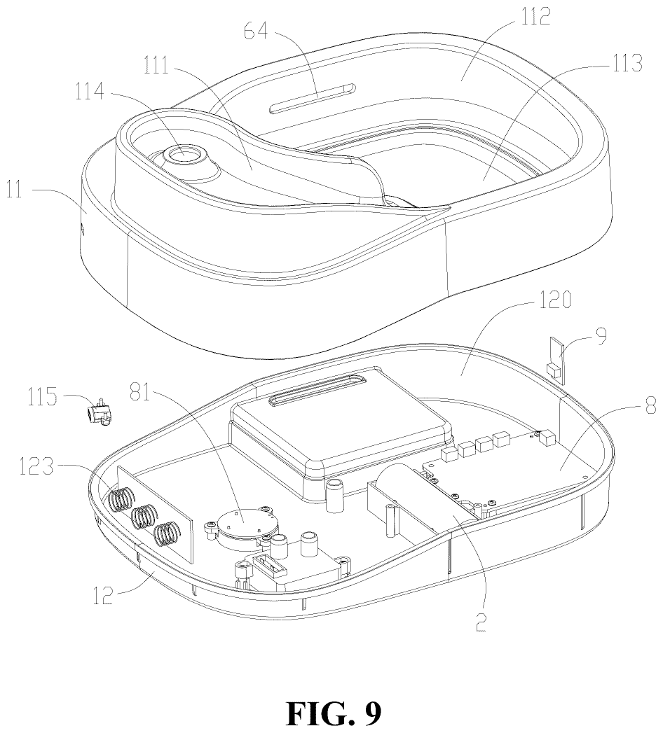

Referring to FIG. 1 to FIG. 9, a pet drinking device 100 provided by this embodiment of the invention includes a water tank 1, a filter element assembly 4, a circuit board 8 arranged on the water tank 1 and a water pumping mechanism 3 electrically connected to the circuit board 8, and the water tank 1 includes a water storage chamber 130 for storing water and a drinking water trough 112 for pets to drink water. The water pumping mechanism 3 is arranged in the water storage chamber 130 and is configured to circulate water in the water storage chamber 130 and the drinking water trough 112 when the circuit board 8 is driven. A filter element assembly 4 includes a softened water quality filter element 42 for softening water quality, a heavy metal filter element 43 for filtering heavy metals and an antibacterial and deodorizing filter element 41 for removing peculiar smell, and the softened water quality filter element 42, the heavy metal filter element 43 and the antibacterial and deodorizing filter element 41 are arranged on the water tank 1 and are configured for filtering water during circulation of water.

The pet drinking device 100 in this embodiment, the softened water quality filter element 42, the antibacterial and deodorizing filter element 41 and the heavy metal filter element 43 are arranged on a water circulation path. Moreover, the softened water quality filter element 42 is configured for softening water quality, the antibacterial and deodorizing filter element 41 is configured for removing the peculiar smell in the circulating water, and the heavy metal filter element 43 is configured for removing the heavy metals in the circulating water. This arrangement effectively removes impurities, odors, heavy metals in the circulating water and inhibits the growth of bacteria, effectively purifies the water quality, ensures the hygiene and safety of pet drinking water, and improves the drinking water quality for pets, which is conducive to the growth, development and health of pets.

In an embodiment, a material of the antibacterial and deodorizing filter element 41 includes nano mineral crystal elements. Among them, by using nano mineral crystal elements, the drinking water quality can be effectively improved, which is conducive to the growth, development and health of pets. In another embodiment, the antibacterial and deodorizing filter element 41 can also be activated carbon or the like.

In an embodiment, the water tank 1 is provided with a filter element housing 5, a drinking water outlet 114 and a backwater channel 6, the filter element housing 5 is arranged on the backwater channel 6, the drinking water outlet 114 is connected to the water pumping mechanism 3 and the drinking water trough 112.

The backwater channel 6 includes a water return port 64 arranged on the water tank 1 and positioned on a sidewall of the drinking water trough 112, at least three accommodating chambers 510 communicating each other and arranged along the circulating water direction in the filter element housing 5, and a filter element water inlet 62 and a filter element water outlet 512 arranged on the filter element housing 5. The water return port 64 is connected to the filter element water inlet 62, each of two sides of the filter element water inlet 62 is respectively connected to the accommodating chamber 510 and the backwater channel 6 positioned on one side, and each of two sides of the filter element water outlet 512 is respectively connected to the accommodating chamber 510 and the water storage chamber 130 positioned on the other side. The filter element assembly 4 includes a softened water quality filter element 42 for softening water quality, a heavy metal filter element 43 for filtering heavy metals and an antibacterial and deodorizing filter element 41 for removing peculiar smell, and the antibacterial and deodorizing filter element 41, the softened water quality filter element 42, and the heavy metal filter element 43 are respectively installed in one accommodating chamber 510.

Through arranging the filter element housing 5 on the backwater channel 6, the filter element assembly 4 can be installed in a limited position. The multiple accommodating chambers 510 arranged in sequence along the circulating water direction are used to respectively limit the filtration of the softened water quality filter element 42, the antibacterial and deodorizing filter element 41, and the heavy metal filter element 43. Thus, the circulating water can all be filtered through the softened water quality filter element 42, the antibacterial and deodorizing filter element 41, and the heavy metal filter element 43, so that each filter element can play a filtering role. This effectively removes impurities, odors, heavy metals in the circulating water and inhibits the growth of bacteria, effectively purifies the water quality, ensures the hygiene and safety of pet drinking water, and improves the drinking water quality for pets, which is conducive to the growth, development and health of pets.

n an embodiment, the antibacterial and deodorizing filter element 41, the softened water quality filter element 42, and the heavy metal filter element 43 are arranged in sequence in the direction adjacent to the filter element water outlet 512. In this way, the water flowing back from the water return port 64 first passes through the antibacterial and deodorizing filter element 41 for filtering to remove odors and inhibit the growth of microorganisms, then passes through the softened water quality filter element 42 to soften the water quality, and finally enters the water storage chamber 130 after the heavy metals are filtered out by the heavy metal filter element 43.

In an embodiment, a height of a bottom surface of the accommodating chamber 510 on one side adjacent to the filter element water inlet 62 is higher than a height of the bottom surface of the accommodating chamber 510 on one side adjacent to the filter element water outlet 512, enabling the water to flow smoothly from the filter element water inlet 62 to the filter element water outlet 512 and be discharged from the latter to the water storage chamber 130.

In an embodiment, the backwater channel 6 further includes a buffer channel 67 arranged on a top of the filter element housing 5, each of two sides of the buffer channel 67 is respectively connected to the water return port 64 and the filter element water inlet 62, and the buffer channel 67 is obliquely arranged downwards along the direction adjacent to the filter element water inlet 62. Through arranging the buffer channel 67, the flow path for the water in the drinking water trough 112 to flow back to the water storage chamber 130 can be increased. Moreover, by setting the buffer channel 67 in an inclined manner, after the water flowing out from the water return port 64 reaches the buffer channel 67, it flows obliquely to the filter element assembly 4, thus playing a role in buffering the water flow. This can effectively reduce the noise generated by the filter element when the water in the drinking water trough 112 directly falls from the water return port 64, serving as a noise reduction measure.

In an embodiment, a partition plate 513 is arranged between each two adjacent accommodating chambers 510 of the at least three accommodating chambers, the backwater channel 6 further includes a first water passage 61 arranged on the filter element housing 5, a first water passage opening 63 arranged on a top of the partition plate 513 close to one side of the filter element water inlet 62, and a second water passage opening 66 arranged on a bottom of the partition plate 513 close to one side the filter element water outlet 512. The buffer channel 67 is connected to the filter element water inlet 62 through the first water passage 61, the filter element water inlet 62 is arranged close to a bottom of the accommodating chamber 510, the first water passage opening 63 is connected to the filter element water inlet 62 through the accommodating chamber 510, and the second water passage opening 66 is connected to the filter element water outlet 512 through the accommodating chamber 510. By using the first water passage 61, the water in the buffer channel 67 can flow to the filter element water inlet 62 close to the bottom of the accommodating chamber 510. Moreover, by utilizing the opening positions of the first water passage opening 63 and the second water passage opening 66, the contact area between the circulating water and the antibacterial and deodorizing filter element 41, the softened water quality filter element 42, and the heavy metal filter element 43 can be effectively increased. This allows for full utilization of the antibacterial and deodorizing filter element 41, the softened water quality filter element 42, and the heavy metal filter element 43 to filter the water and improve the filtering effect.

In an embodiment, the backwater channel 6 further includes a second water passage 65 arranged on the water tank 1, the second water passage 65 is positioned on the filter element housing 5, and each of two sides of the second water passage 65 is respectively connected to the buffer channel 67 and the water return port 64. By using the second water passage 65, the water flowing out from the water return port 64 can be guided into the buffer channel 67.

In an embodiment, the filter element housing includes a filter element surface housing 51 and a filter element bottom housing 52, the filter element surface housing 51 is connected to the filter element bottom housing 52 form the accommodating chamber 510, the first water passage 61 and the filter element water inlet 62, the buffer channel 67 is arranged on a top portion of the filter element surface housing 51, the partition plate 513 is arranged on the filter element surface housing 51, and the filter element water outlet 512 is arranged on the filter element bottom housing 52. Dividing the filter element housing 5 into a filter element face housing 51 and a filter element bottom housing 52 can facilitate the production and manufacturing of the filter element assembly 4 and the installation of the antibacterial and deodorizing filter element 41, the softened water quality filter element 42, and the heavy metal filter element 43 in the accommodating chamber 510.

Referring to FIG. 1, in an embodiment, a water flow trough 111 is further arranged on a top portion of the water tank 1, the water flow trough 111 is connected to the drinking water trough 112, a height of one end of the water flow trough 111 connected to the drinking water trough 112 is lower than a height of one end of the water flow trough 111 far away from the drinking water trough 112, and the drinking water outlet 114 is arranged on a bottom surface of the water flow trough 111 and is positioned at the end of the water flow trough 111 far away from the drinking water trough 112. By using the water flow trough 111, the water coming out from the drinking water outlet 114 can flow into the drinking water trough 112 to form a flowing water source, so as to attract pets to drink more water. Moreover, allowing pets to directly drink the water treated by the antibacterial and deodorizing filter element 41, the softened water quality filter element 42, the heavy metal filter element 43 and the electrolysis module 7 can be beneficial to the healthy growth of pets.

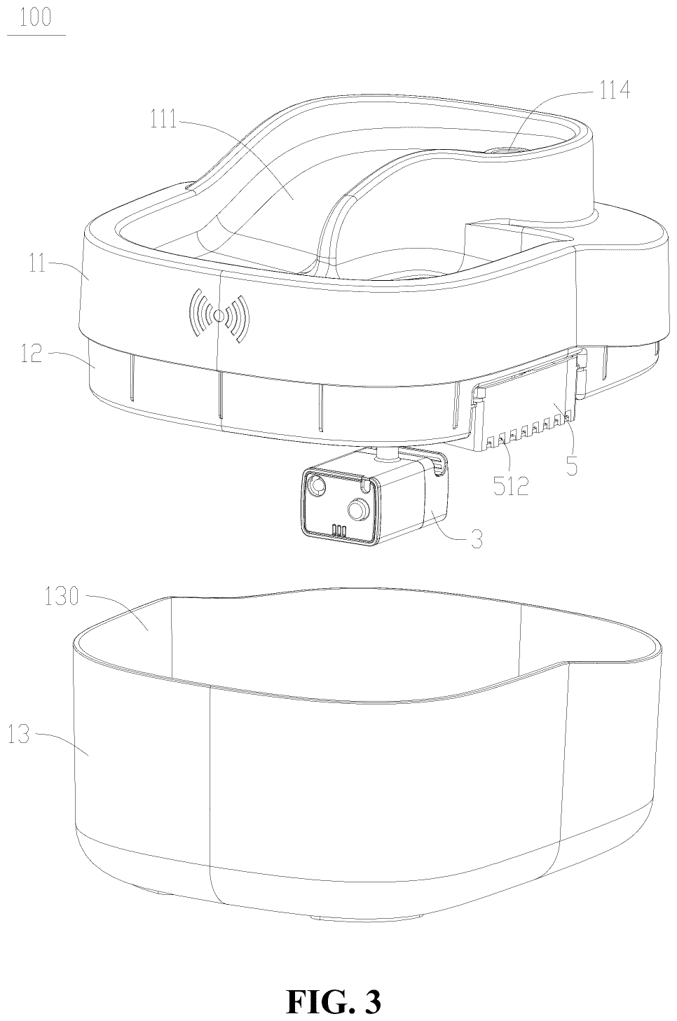

Referring to FIG. 3 to FIG. 6 and FIG. 9, in an embodiment, for the convenience of production and manufacturing of the pet drinking device 100 in this embodiment and the compactness of the structure, the water tank 1 includes a main body bottom housing 13 and an upper main body 10 detachably connected to the main body bottom housing 13, the water storage chamber 130 is formed by connecting the upper main body 10 and the main body bottom housing 13, the drinking water outlet 114, the water return port 64, the water pumping mechanism 3, the filter element housing 5 and the circuit board 8 are arranged on the upper main body 10.

In an embodiment, the the filter element housing 5 is detachably arranged on the upper main body 10 so that the user can replace the filter element housing 5 and the filter element assembly 4, improve the service life of the pet drinking device 100 in this embodiment, and ensure the drinking water health of pets.

In an embodiment, a storage groove 121 for accommodating the filter element housing 5 is provided at a bottom of the upper main body 10, a supporting block 122 protrudes from a side wall of the upper main body 10 corresponding to the storage groove 121, a butting block configured in cooperation with the supporting block 122 is provided on the filter element housing 5, and the butting block is positioned above the supporting block 122 when the filter element housing 5 is placed in the storage groove 121. By using the supporting block 122 to support and abut against the abutting block, the filter element housing 5 is supported. Thus, the filter element housing 5 is arranged on the upper main body 10 in a drawer-like manner, so that the user can assemble the filter element housing 5 onto the upper main body 10 or disassemble it from the upper main body 10.

In an embodiment, the upper main body 10 is provided with a battery 2 electrically connected to the circuit board 8. By using the battery 2 to supply power to the circuit board 8, a power supply connected through a power line can be omitted, wiring is reduced, and convenience is brought to users.

In an embodiment, the battery 2 is a rechargeable battery, the upper main body 10 is provided with a charging interface 115 for external connection of a power supply, and the charging interface 115 is electrically connected to the circuit board 8. By connecting to the power supply through the power line adapted to the charging interface 115, the battery 2 can be charged through the circuit board 8.

In an embodiment, a UV lamp 81 connected to the circuit board 8 is arranged on a bottom of the middle housing 12. When the UV lamp 81 is turned on, ultraviolet rays are effectively irradiated on the water. And by using the ultraviolet rays emitted by the UV lamp 81, the pet drinking water can be further sterilized and disinfected, improving the water quality of pet drinking water.

In an embodiment, the main body surface housing 11 is provided with a functional operating part 123 electrically connected to the circuit board 8, and the circuit board 8 is configured to control working of the water pumping mechanism 3 or adjust driving pow of the electrolysis module 7 when a user operates the functional operating part 123. Specifically, the functional operating part 123 can be a touch key, a push switch, a DIP switch, etc. When the user operates the functional operating part 123, one or more of the water pumping mechanism 3, the electrolysis module 7, and the UV lamp 81 can be driven to turn on or off through the circuit board 8, so that the user can operate and use the pet drinking device 100 in the embodiment.

In an embodiment, a wireless module 9 configured to communicate with an external equipment is arranged in the mounting chamber 120, and the wireless module 9 is electrically connected to the circuit board 8. The device in the embodiment can realize wireless communication with external devices like mobile phones, tablets, and remote controls through the wireless module 9. This enables one or more of the water pumping mechanism 3, the electrolysis module 7, and the UV lamp 81 to be controlled to turn on or off through external devices such as mobile phones, tablets, and remote controls, improving the convenience of user use.

In an embodiment, a metal water basin 113 is arranged on the main body surface housing 11. The metal water basin 113 is fixed to the main body surface housing 11 when the main body surface housing 11 is injection molded. A bottom surface and a side wall of the metal water basin 113 are respectively a bottom surface and at least part of side wall of the drinking water trough 112. Specifically, using an inner side wall of the metal water basin 113 as part of the side wall of the drinking water trough 112 can facilitate subsequent cleaning.

The above description only describes embodiments of the present disclosure, and is not intended to limit the present disclosure; various modifications and changes can be made to the present disclosure. Any modifications, equivalent substitutions, and improvements made within the spirit and scope of the present disclosure are intended to be included within the scope of the present disclosure.

What is claimed is:

1. A pet drinking device, comprising:
a water tank comprising a water storage chamber for storing water and a drinking water trough for pets to drink water;
a circuit board arranged on the water tank;
a water pumping mechanism electrically connected to the circuit board, the water pumping mechanism arranged in the water storage chamber and configured to circulate water in the water storage chamber and the drinking water trough when the circuit board is driven; and
a filter element assembly, wherein the filter element assembly comprises a softened water quality filter element for softening water quality, a heavy metal filter element for filtering heavy metals and an antibacterial and deodorizing filter element for removing peculiar smell, the softened water quality filter element, the heavy metal filter element and the antibacterial and deodorizing filter element are arranged on the water tank for filtering water during water circulation.

2. The pet drinking device according to claim 1, wherein a material of the antibacterial and deodorizing filter element comprises nano mineral crystal elements.

3. The pet drinking device according to claim 1, wherein the water tank is provided with a filter element housing, a drinking water outlet and a backwater channel, the filter element housing is arranged on the backwater channel, and the drinking water outlet is connected to the water pumping mechanism and the drinking water trough; the backwater channel comprises a water return port arranged on the water tank and positioned on a sidewall of the drinking water trough, at least three accommodating chambers communicating each other and arranged along the circulating water direction in the filter element housing, and a filter element water inlet and a filter element water outlet arranged on the filter element housing; the water return port is connected to the filter element water inlet, each of two sides of the filter element water inlet is respectively connected to the accommodating chamber and the backwater channel positioned on one side, and each of two sides of the filter element water outlet is respectively connected to the accommodating chamber and the water storage chamber positioned on the other side; the antibacterial and deodorizing filter element, the softened water quality filter element, and the heavy metal filter element are respectively installed in one accommodating chamber.

4. The pet drinking device according to claim 3, wherein the antibacterial and deodorizing filter element, the softened water quality filter element, and the heavy metal filter element are arranged in sequence in the direction adjacent to the filter element water outlet.

5. The pet drinking device according to claim 3, wherein a height of a bottom surface of the accommodating chamber on one side adjacent to the filter element water inlet is higher than a height of the bottom surface of the accommodating chamber on one side adjacent to the filter element water outlet.

6. The pet drinking device according to claim 3, wherein the backwater channel further comprises a buffer channel arranged on a top of the filter element housing, each of two sides of the buffer channel is respectively connected to the water return port and the filter element water inlet, and the buffer channel is obliquely arranged downwards along the direction adjacent to the filter element water inlet.

7. The pet drinking device according to claim 6, wherein a partition plate is arranged between each two adjacent accommodating chambers of the at least three accommodating chambers, the backwater channel further comprises a first water passage arranged on the filter element housing, a first water passage opening arranged on a top of the partition plate close to one side of the filter element water inlet, and a second water passage opening arranged on a bottom of the partition plate close to one side the filter element water outlet; the buffer channel is connected to the filter element water inlet through the first water passage, the filter element water inlet is arranged close to a bottom of the accommodating chamber, the first water passage opening is connected to the filter element water inlet through the accommodating chamber, and the second water passage opening is connected to the filter element water outlet through the accommodating chamber.

8. The pet drinking device according to claim 7, wherein the backwater channel further comprises a second water passage arranged on the water tank, the second water passage is positioned on the filter element housing, and each of two sides of the second water passage is respectively connected to the buffer channel and the water return port.

9. The pet drinking device according to claim 7, wherein the filter element housing comprises a filter element surface housing and a filter element bottom housing, the filter element surface housing is connected to the filter element bottom housing form the accommodating chamber, the first water passage and the filter element water inlet, the buffer channel is arranged on a top portion of the filter element surface housing, the partition plate is arranged on the filter element surface housing, and the filter element water outlet is arranged on the filter element bottom housing.

10. The pet drinking device according to claim 3, wherein a water flow trough is further arranged on a top portion of the water tank, the water flow trough is connected to the drinking water trough, a height of one end of the water flow trough connected to the drinking water trough is lower than a height of one end of the water flow trough far away from the drinking water trough, and the drinking water outlet is arranged on a bottom surface of the water flow trough and is positioned at the end of the water flow trough far away from the drinking water trough.

11. The pet drinking device according to claim 3, wherein the water tank comprises a main body bottom housing and an upper main body detachably connected to the main body bottom housing, the water storage chamber is formed by connecting the upper main body and the main body bottom housing, the drinking water outlet, the water return port, the water pumping mechanism and the circuit board are arranged on the upper main body.

12. The pet drinking device according to claim 11, wherein the filter element housing is detachably arranged on the upper main body.

13. The pet drinking device according to claim 12, wherein a storage groove for accommodating the filter element housing is provided at a bottom of the upper main body, a supporting block protrudes from a side wall of the upper main body corresponding to the storage groove, a butting block configured in cooperation with the supporting block is provided on the filter element housing, and the butting block is positioned above the supporting block when the filter element housing is placed in the storage groove.

14. The pet drinking device according to claim 11, wherein the upper main body is provided with a battery electrically connected to the circuit board.

15. The pet drinking device according to claim 14, wherein the battery is a rechargeable battery, the upper main body is provided with a charging interface for external connection of a power supply, and the charging interface is electrically connected to the circuit board.

16. The pet drinking device according to claim 14, wherein the upper main body comprises a middle housing and a main body surface housing connected to the middle housing to form a mounting chamber, the circuit board and the battery are arranged in the mounting chamber, the water storage chamber is formed by surrounding the middle housing and the main body bottom housing, the drinking water outlet and the water return port are arranged on the main body surface housing, the water pumping mechanism 3 is connected to the drinking water outlet through a tube, and the tube passes through the middle housing.

17. The pet drinking device according to claim 16, wherein the main body surface housing is provided with a functional operating part electrically connected to the circuit board, and the circuit board is configured to control working of the water pumping mechanism or adjust driving pow of the electrolysis module when a user operates the functional operating part.

18. The pet drinking device according to claim 16, wherein a wireless module configured to communicate with an external equipment is arranged in the mounting chamber, and the wireless module is electrically connected to the circuit board.

19. The pet drinking device according to claim 16, wherein a UV lamp connected to the circuit board is arranged on a bottom of the middle housing.

20. The pet drinking device according to claim 16, wherein a metal water basin is arranged on the main body surface housing, the metal water basin is fixed with the main body surface housing during injection molding of the main body surface housing, and a bottom surface and a side wall of the metal water basin are respectively a bottom surface and at least part of side wall of the drinking water trough.
